(19) United States
(12) Patent Application Publication
(10) Pub. No.: US 2025/0106720 A1
(43) Pub. Date: Mar. 27, 2025

(54) LOGGING AND REPORTING MULTIPLE RANDOM ACCESS PROCEDURE INFORMATION WHILE PERFORMING DUAL ACTIVE PROTOCOL STACK HANDOVER

(71) Applicant: Telefonaktiebolaget LM Ericsson (publ), Stockholm (SE)

(72) Inventors: Ali PARICHEHREHTEROUJENI, Linköping (SE); Pradeepa RAMACHANDRA, Linköping (SE); Marco BELLESCHI, Solna (SE)

(21) Appl. No.: 18/729,110

(22) PCT Filed: Feb. 10, 2023
(86) PCT No.: PCT/SE2023/050111

§ 371 Date: Jul. 15, 2024

Related U.S. Application Data
(60) Provisional application No. 63/309,481, filed on Feb. 11, 2022.

(51) Int. Cl. H04W 36/18; H04W 74/0833

(52) U.S. Cl. CPC H04W 36/185; H04W 74/0833

(57) ABSTRACT

A communication device of a communications network can perform a dual active protocol stack (“DAPS”) handover (“HO”) from a source cell associated with a first network node of the communications network to a target cell associated with a second network node of the communications network. Performing the DAPS HO can include performing a first random access (“RA”) procedure with the source cell and performing a second RA procedure with the target cell. The communication device can determine RA content to include in a report associated with the DAPS HO. The communication device can transmit the report to a third network node of the communications network toward a target cell.

### TECHNICAL FIELD

The present disclosure is related to wireless communication systems and more particularly to calculating communication device mobility state using reference frequency.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

A Self-Organizing Network (“SON”) is an automation technology designed to make the planning, configuration, management, optimization, and healing of mobile radio access networks simpler and faster. SON functionality and behavior has been defined and specified in generally accepted mobile industry recommendations produced by organizations such as the 3rd Generation Partnership Project (“3GPP”) and the Next Generation Mobile Networks (“NGMN”).

In 3GPP, the processes within the SON area are classified into Self-configuration process and Self-optimization process as illustrated in FIG. 2.

Self-configuration process is the process where newly deployed nodes are configured by automatic installation procedures to get the necessary basic configuration for system operation. This process works in pre-operational state. Pre-operational state is understood as the state from when the eNB is powered up and has backbone connectivity until the RF transmitter is switched on. For example, in FIG. 2, basic setup and initial radio configuration are covered by the self-configuration process.

Self-optimization process is defined as the process where UE and access node measurements and performance measurements are used to auto-tune the network. For example, in FIG. 2, optimization/adaptation are covered by the self-optimization process.

### SUMMARY

There currently exist certain challenges. According to the current agreements and the running CR of 3GPP RRC technical specification (R2-2200004), a UE can execute a Dual Active Protocol Stack (“DAPS”) handover (“HO”), or a reconfiguration with sync with DAPS bearer configuration, toward a target cell and at the time of execution performs two/multiple random access (“RA”) procedures. Two non-limiting examples are described below.

In one example, while executing the DAPS HO (i.e., while timer T304 is running) the UE may experience a RLF in the source due to a BFR failure (led to second RA-InformationCommon) and then the UE fails (T304 expires) in executing DAPS toward target cell due to random access procedure failure (led to second RA-InformationCommon).

In a second example, while executing the DAPS HO (i.e., while timer T304 is running) the UE may experience a RLF in the source due to a beam failure recovery failure or any other random access problem (led to a first RA-InformationCommon) and then succeeds in executing DAPS toward target cell (led to a second RA-InformationCommon).

In the first example, the UE shall log RLF report. However, from the current RRC running CR (R2-2200004), it is not clear how the UE shall treat the executed multiple RA procedures' information at the time of logging the RLF report (e.g., whether to log the information pertaining to the first RACH toward the source cell or the information pertaining to the second RACH toward the target cell or the information pertaining to both RA procedures).

In the second example, the UE shall log SHR report if configured by the network. However, from the current RRC running CR (R2-2200004), it is not clear how the UE shall treat the executed multiple RA procedures' information at the time of logging the SHR report (e.g., whether to log the information pertaining to the first RACH toward the source cell or the information pertaining to the second RACH toward the target cell or the information pertaining to both RA procedures).

Certain aspects of the disclosure and their embodiments may provide solutions to these or other challenges. Various embodiments described herein provide operations performed by a communication device (also referred to as a wireless terminal or a User Equipment (“UE”)) that cause the communication device to log/compile a report upon execution of a DAPS HO or a reconfiguration with sync including a DAPS bearer configuration, whereas the report is a RLF report (if the DAPS HO fails) or the report is a successful HO report and a radio connection failure report (e.g., RLF or HOF) upon execution of a mobility procedure such as a handover, or a reconfiguration with sync procedure.

In some embodiments, the communication device executes/performs a DAPS HO toward a target cell after receiving a reconfiguration with sync command from the network node, and executes/performs a first random-access procedure toward source cell while performing DAPS HO, and executing a second random access procedure toward the target as part of DAPS HO. The communication device can further determine content of a report to be sent to the network after execution of the handover. For example, the communication device can determine whether to include the information of the first random access procedure and/or information of the second random access procedure. The communication device can further log the content of the report (as determined to include the information from the first and/or the second random access procedure). In some examples, the communication device can perform some further optimizations in terms of what parameters to include for first random access procedure and the second random access procedure. The communication device can further send the report to the network node.

In additional or alternative embodiments, the content of a report that a UE sends to the network after execution of a DAPS HO can be determined. For example, when a UE executes at least two random access procedures while executing DAPS HO, it can determine which random access procedure related information e.g., RA-InformationCommon to be logged as part of the report. Note that the UE can executes at least one random access procedure toward a source cell and one random access procedure toward a target cell while handover supervision time (e.g., T304 timer) is running (which can also be referred to as while the UE is performing the HO).

In additional or alternative embodiments, if the HO fails, the UE logs RLF report and determines to log the information of the first random access procedure performed toward source cell, or the information of the second random access procedure performed toward target cell, or the information of both (the first and the second) random access procedures performed toward source and target cells, in the RLF report.

In additional or alternative embodiments, if the HO succeeds but the UE is configured with successful handover report configuration, UE may log successful handover report (SHR), if one of the successful handover report conditions is met, and UE determines to log the information of the first random access procedure performed toward source cell, or the information of the second random access procedure performed toward target cell, or the information of both random access procedures performed toward source and target cells, in the SHR report.

According to some embodiments, a method of operating a communication device of a communications network is provided. The method includes performing a dual active protocol stack, DAPS, handover, HO, from a source cell associated with a first network node of the communications network to a target cell associated with a second network node of the communications network, which includes performing a first random access, RA, procedure with the source cell and performing a second RA procedure with the target cell. The method further includes determining RA content to include in a report associated with the DAPS HO. The method further includes transmitting (550) the report to a third network node of the communications network toward a target cell.

According to other embodiments, a method of operating a network node of a communications network is provided. The method includes performing a random access, RA, procedure with a communication device as part of a dual active protocol stack, DAPS, handover, HO, of the communication device from a source cell to a target cell. The method further includes receiving a report including RA content associated with the DAPS HO.

According to other embodiments, a communication device, network node, system, host, computer program, computer program product, or non-transitory computer readable medium is provided to perform one of the above methods.

Certain embodiments may provide one or more of the following technical advantages. Some embodiments enable the UE to log the random-access information in a predetermined way according to the procedure specified in 3GPP specifications (e.g., TS 38.331) or according to a configuration received from the network. As a result, the network node receiving the report (RLF or SHR) after execution of the HO, will recognize if the random-access related information belongs to the source cell or to the target cell of the handover. Therefore, further optimization concerning the RA procedure would not be misled.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5th generation (“5G”) network;

FIG. 2 is a block diagram illustrating an example of Self-Configuration/Self-Optimization functionality in a self-organizing network;

FIG. 3 is a signal flow diagram illustrating an example of operations performed for logging random access information while performing a dual active protocol stack handover that has failed in accordance with some embodiments;

FIG. 4 is a signal flow diagram illustrating an example of operations performed for logging random access information while performing a dual active protocol stack handover that has succeeded in accordance with some embodiments;

FIG. 5 is a flow chart illustrating an example of operations performed by a communication device in accordance with some embodiments;

FIG. 6 is a flow chart illustrating an example of operations performed by a network node in accordance with some embodiments;

FIG. 7 is a block diagram of a communication system in accordance with some embodiments;

FIG. 8 is a block diagram of a user equipment in accordance with some embodiments

FIG. 9 is a block diagram of a network node in accordance with some embodiments;

FIG. 10 is a block diagram of a host computer communicating with a user equipment in accordance with some embodiments;

FIG. 11 is a block diagram of a virtualization environment in accordance with some embodiments; and

FIG. 12 is a block diagram of a host computer communicating via a base station with a user equipment over a partially wireless connection in accordance with some embodiments in accordance with some embodiments.

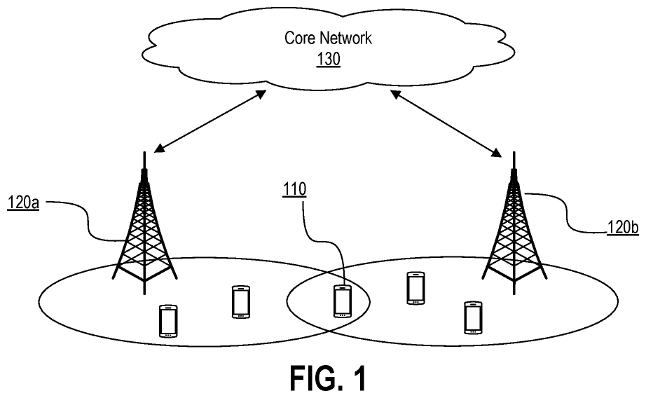

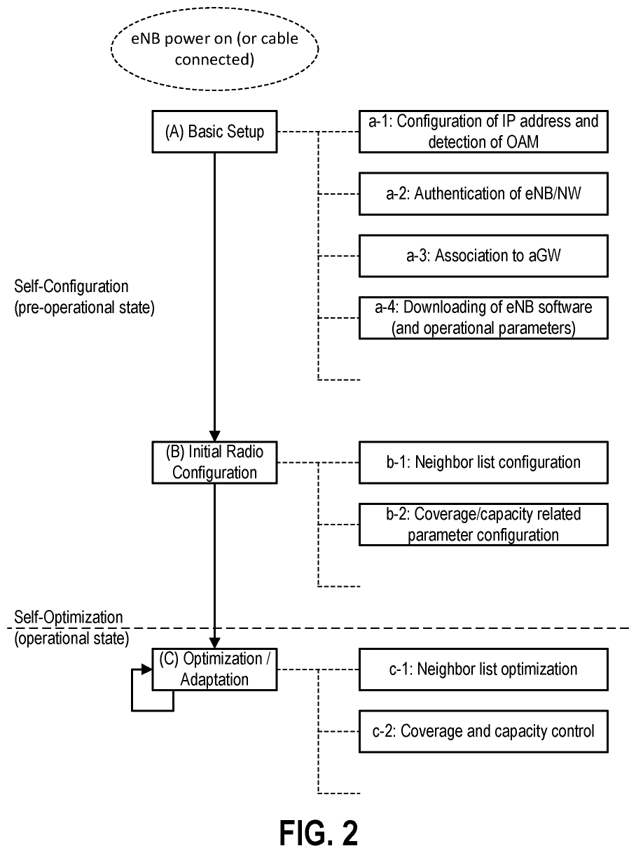

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

In long term evolution (“LTE”), support for Self-Configuration and Self-Optimization is specified, as described in 3GPP TS 36.300 section 22.2, including features such as Dynamic configuration, Automatic Neighbour Relation (“ANR”), Mobility load balancing, Mobility Robustness Optimization (“MRO”), Random Access Channel (“RACH”) optimization, and support for energy saving.

In NR, support for Self-Configuration and Self-Optimization are specified as well, starting with Self-Configuration features such as Dynamic configuration, and Automatic ANR in Rel-15, as described in 3GPP TS 38.300 section 15. In NR Rel-16, more SON features are being specified, including Self-Optimization features such as MRO.

MRO in 3GPP is described below.

Seamless handovers are a key feature of 3GPP technologies. Successful handovers ensure that the UE moves around in the coverage area of different cells without causing too much interruptions in the data transmission. However, there will be scenarios when the network fails to handover the UE to the ‘correct’ neighbor cell in time and in such scenarios the UE will declare the radio link failure (“RLF”) or Handover Failure (“HOF”).

Upon HOF and RLF, the UE may take autonomous actions (e.g., trying to select a cell and initiate reestablishment procedure) so that the UE is trying to get back as soon as it can, so that it can be reachable again. The RLF will cause a poor user experience as the RLF is declared by the UE only when it realizes that there is no reliable communication channel (radio link) available between itself and the network. Also, reestablishing the connection requires signaling with the newly selected cell (random access procedure, radio resource control (“RRC”) Reestablishment Request, RRC Reestablishment, RRC Reestablishment Complete, RRC Reconfiguration, and RRC Reconfiguration Complete) and adds some latency, until the UE can exchange data with the network again.

The possible causes for the radio link failure could be several in the NR specification including for example: expiry of the radio link monitoring related timer T310; the expiry of the measurement reporting associated timer T312 (not receiving the handover command from the network within this timer's duration despite sending the measurement report when T310 was running); reaching the maximum number of radio link control (“RLC”) retransmissions; upon receiving random access problem indication from the media access control (“MAC”) entity; upon declaring consistent LBT failures in the SpCell operating in the unlicensed spectrum; and upon failing the beam failure recovery procedure.

On the other hand, the HOF is due to the expiry of T304 timer while performing the handover to the target cell.

As RLF or HOF leads to reestablishment which degrades performance and user experience, it is in the interest of the network to understand the reasons for RLF and try to optimize mobility related parameters (e.g., trigger conditions of measurement reports) to avoid later RLFs. Before the standardization of MRO related report handling in the network, only the UE was aware of some information associated to how the radio quality looked like at the time of RLF and what is the actual reason for declaring RLF. For the network to identify the reason for the RLF, the network needs more information, both from the UE and also from the neighboring base stations.

After the RLF is declared, the RLF report is logged and included in the VarRLF-Report and, once the UE selects a cell and succeeds with a reestablishment, it includes an indication that it has an RLF report available in the RRC Reestablishment Complete message, to make the target cell aware of that availability. Then, upon receiving an UEInformationRequest message with a flag “rlf-ReportReq-r9” the UE shall include the RLF report (stored in a UE variable VarRLF-Report, as described above) in an UEInformationResponse message and send to the network.

Based on the RLF report from the UE and the knowledge about which cell the UE reestablished itself, the original source cell can deduce whether the RLF was caused due to a coverage hole or due to handover associated parameter configurations. If the RLF was deemed to be due to handover associated parameter configurations, the original serving cell can further classify the handover related failure as too-early, too-late or handover to wrong cell classes. These handover failure classes are briefly explained below.

In some examples, if the handover failure occurred due to the ‘too-late handover’ cases, the original serving cell can classify a handover failure to be ‘too late handover’ when the original serving cell fails to send the handover command to the UE associated to a handover towards a particular target cell and if the UE reestablishes itself in this target cell post RLF. An example corrective action from the original serving cell could be to initiate the handover procedure towards this target cell a bit earlier by decreasing the CIO (cell individual offset) towards the target cell that controls when the IE sends the event triggered measurement report that leads to taking the handover decision.

In some examples, if the handover failure occurred due to the ‘too-early handover’ cases, the original serving cell can classify a handover failure to be ‘too early handover’ when the original serving cell is successful in sending the handover command to the UE associated to a handover however the UE fails to perform the random access towards this target cell. An example corrective action from the original serving cell could be to initiate the handover procedure towards this target cell a bit later by increasing the CIO (cell individual offset) towards the target cell that controls when the IE sends the event triggered measurement report that leads to taking the handover decision.

In some examples, if the handover failure occurred due to the ‘handover-to-wrong-cell’ cases, the original serving cell can classify a handover failure to be ‘handover-to-wrong-cell’ when the original serving cell intends to perform the handover for this UE towards a particular target cell but the UE declares the RLF and reestablishes itself in a third cell. A corrective action from the original serving cell could be to initiate the measurement reporting procedure that leads to handover towards the target cell a bit later by decreasing the CIO (cell individual offset) towards the target cell or via initiating the handover towards the cell in which the UE reestablished a bit earlier by increasing the CIO towards the reestablishment cell.

Successful Handover Report (“SHR”) is described below.

The MRO function in NR could be enhanced to provide a more robust mobility via reporting failure events observed during successful handovers. A solution to this problem is to configure the UE to compile a report associated to a successful handover comprising a set of measurements collected during the handover phase, i.e. measurement at the handover trigger, measurement at the end of handover execution or measurement after handover execution. The UE could be configured with triggering conditions to compile the Successful Handover Report, hence the report would be triggered only if the conditions are met. This limits UE reporting to relevant cases, such as underlying issues detected by radio link management (“RLM”), or beam failure detection (“BFD”) detected upon a successful handover event.

The availability of a Successful Handover Report may be indicated by the Handover Complete message (RRCReconfigurationComplete) transmitted from UE to target NG-RAN node over RRC. The target NG-RAN node may fetch information of a successful handover report via UE Information Request/Response mechanism. In addition, the target NG-RAN node could then forward the Successful Handover Report to the source NR-RAN node to indicate failures experienced during a successful handover event.

The information contained in the successful handover report may include: RLM related information (e.g., RLM related timers (e.g. T310, T312), Measurements of reference signals used for RLM in terms of reference signal received power (“RSRP”), reference signal received quality (“RSRQ”), signal-to-interference-and-noise ratio (“SINR”), and RLC retransmission counter); BFD related information (e.g., Detection indicators and counters (e.g. Qin and Qout indications) and Measurements of reference signals used in BFD in terms of RSRP, RSRQ, SINR); and Handover related information (e.g., Measurements of the configured reference signals at the time of successful handover including Synchronization signal block (“SSB”) beam measurements and Channel state information reference signal (“CSI-RS”) measurements, Handover related timers (e.g. T304), and Measurement period indication, i.e. measurements are collected at handover trigger, at the end of handover execution or just after handover execution).

Upon reception of a Successful HO Report, the receiving node is able to analyze whether its mobility configuration needs adjustment. Such adjustments may result in changes of mobility configurations, such as changes of RLM configurations or changes of mobility thresholds between the source and the target. In addition, target NG RAN node, in the performed handover, may further optimize the dedicated RACH-beam resources based on the beam measurements reported upon successful handovers.

There currently exist certain challenges. According to the current agreements and the running CR of 3GPP RRC technical specification (R2-2200004), a UE can execute a Dual Active Protocol Stack (“DAPS”) handover (“HO”), or a reconfiguration with sync with DAPS bearer configuration, toward a target cell and at the time of execution performs two/multiple random access (“RA”) procedures. Two non-limiting examples are described below.

In one example, while executing the DAPS HO (i.e., while timer T304 is running) the UE may experience a RLF in the source due to a BFR failure (led to second RA-InformationCommon) and then the UE fails (T304 expires) in executing DAPS toward target cell due to random access procedure failure (led to second RA-InformationCommon).

In a second example, while executing the DAPS HO (i.e., while timer T304 is running) the UE may experience a RLF in the source due to a beam failure recovery failure or any other random access problem (led to a first RA-InformationCommon) and then succeeds in executing DAPS toward target cell (led to a second RA-InformationCommon).

In the first example, the UE shall log RLF report. However, from the current RRC running CR (R2-2200004), it is not clear how the UE shall treat the executed multiple RA procedures' information at the time of logging the RLF report (e.g., whether to log the information pertaining to the first RACH toward the source cell or the information pertaining to the second RACH toward the target cell or the information pertaining to both RA procedures).

In the second example, the UE shall log SHR report if configured by the network. However, from the current RRC running CR (R2-2200004), it is not clear how the UE shall treat the executed multiple RA procedures' information at the time of logging the SHR report (e.g., whether to log the information pertaining to the first RACH toward the source cell or the information pertaining to the second RACH toward the target cell or the information pertaining to both RA procedures).

Certain aspects of the disclosure and their embodiments may provide solutions to these or other challenges. Various embodiments described herein provide operations performed by a communication device (also referred to as a wireless terminal or a User Equipment (“UE”)) that cause the communication device to log/compile a report upon execution of a DAPS HO or a reconfiguration with sync including a DAPS bearer configuration, whereas the report is a RLF report (if the DAPS HO fails) or the report is a successful HO report and a radio connection failure report (e.g., RLF or HOF) upon execution of a mobility procedure such as a handover, or a reconfiguration with sync procedure.

Certain embodiments may provide one or more of the following technical advantages. Some embodiments enable the UE to log the random-access information in a predetermined way according to the procedure specified in 3GPP specifications (e.g., TS 38.331) or according to a configuration received from the network. As a result, the network node receiving the report (RLF or SHR) after execution of the HO, will recognize if the random-access related information belongs to the source cell or to the target cell of the handover. Therefore, further optimization concerning the RA procedure would not be misled.

Various embodiments herein are described in regards to two different scenarios: 1) when an executed dual active protocol stack (“DAPS”) handover (“HO”) has failed and the communication device determines (e.g., logs/compiles) a radio link failure (“RLF”) report; and 2) when an executed DAPS HO is successful and the communication device logs/compiles a successful handover report (“SHR”).

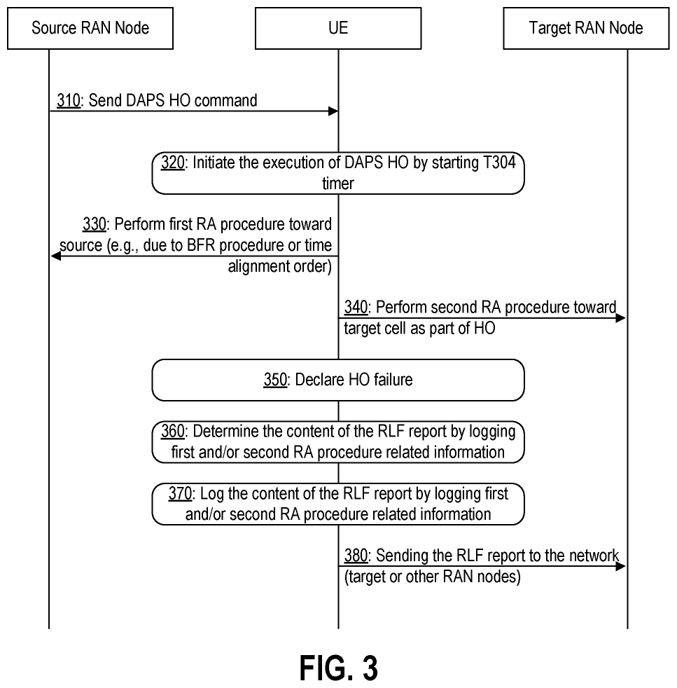

FIG. 3 illustrates an example of a dual random access (“RA”) related information logging as part of a RLF report. At block 310, the source RAN node transmits a DAPS HO command to the UE. At block 320, the UE initiates the execution of DAPS HO by starting a T304 timer. At block 330, the UE performs a first RA procedure toward the source RAN node. At block 340, the UE performs a second RA procedure towards a target cells as part of a HO. At block 350, the UE declares a HO failure. At block 360, the UE determines the content of the RLF report by logging first and/or second RA procedure related information. At block 370, the UE logs the content of the RLF report by logging first and/or second RA procedure related information. At block 380, the UE transmits the RLF report to the network.

In some embodiments, the communication device performs a DAPS HO toward a target cell after receiving a reconfiguration with sync command from the network node, and performs a first RA procedure toward a source cell while performing DAPS HO, and while performing a second RA procedure toward the target as part of the DAPS HO that led to a DAPS HO failure.

In additional or alternative embodiments, the communication device further determines content of an RLF report (logged after a DAPS HO failure) to be sent to the network after failure in the execution of the DAPS HO. For example, the communication device determines whether to include the information of the first RA procedure and/or the information of the second RA procedure. In some examples, the UE logs the information pertaining to the first RA procedure performed toward the source cell (e.g., RA-InformationCommon pertaining to the first RA procedure). In additional or alternative examples, the UE logs the information pertaining to the RA procedure performed toward the target cell (e.g., RA-InformationCommon pertaining to the second RA procedure). In additional or alternative examples, the UE logs the information pertaining to both RA procedures performed toward the source and the target RAN nodes (e.g., two RA-InformationCommon one pertaining to the first RA procedure and one pertaining to the second RA procedure).

In some examples, the communication device determines the content of the RLF report based on the procedural text in RRC TS 38.331 explicitly indicating to collect which RA information.

In additional or alternative examples, the communication device determines the RA report information as part of the RLF report based on the configuration received from the network node (e.g., a gNB or OAM or SMO). For example, the network node instructs the UE to log the RA information pertaining to the source cell, the RA information pertaining to the target cell, or the information pertained to both of RA procedure.

In additional or alternative embodiments, the communication device logs the content of the report. In some examples, if the frequency resources used for the first random access procedure and the second random access procedure is the same, then the UE includes one set of information associated to the frequency resources that is common to the first random access procedure and the second random access procedure and the UE also includes another set of information associated to each random access attempts in the first random access procedure and the second random access procedure. By doing so, the UE reduces the size of the report.

In additional or alternative embodiments, the communication device transmits the report to the network node (e.g., via a UE Information request Response procedure).

A non-limiting example of the operations illustrated in FIG. 3 are in the modified portion of the 3GPP technical specification 38.331 below:
1>if connectionFailureType is rlf and the rlf-Cause is set to randomAccessProblem or beamFailureRecoveryFailure; or
1>if connectionFailure Type is hof and if the failed handover is an intra-RAT handover:
   2>set the ra-InformationCommon to include the random-access related information executed as part of handover (or reconfiguration with sync) toward target cell

Another non-limiting example the operations illustrated in FIG. 3 are in the modified portion of the 3GPP technical specification 38.331 below:
1>if connectionFailureType is rlf and the rlf-Cause is set to randomAccessProblem or beamFailureRecoveryFailure; or
1>if connectionFailure Type is hof and if the failed handover is an intra-RAT handover:
   2>set the ra-InformationCommon to include the random-access related information executed as part of handover (or reconfiguration with sync) toward target cell
   2>if a random access procedure was performed toward the source cell while T304 was running and any DAPS bearer was configured, set the ra-InformationCommonSource to include the random-access related information executed as part of handover (or reconfiguration with sync) toward source cell

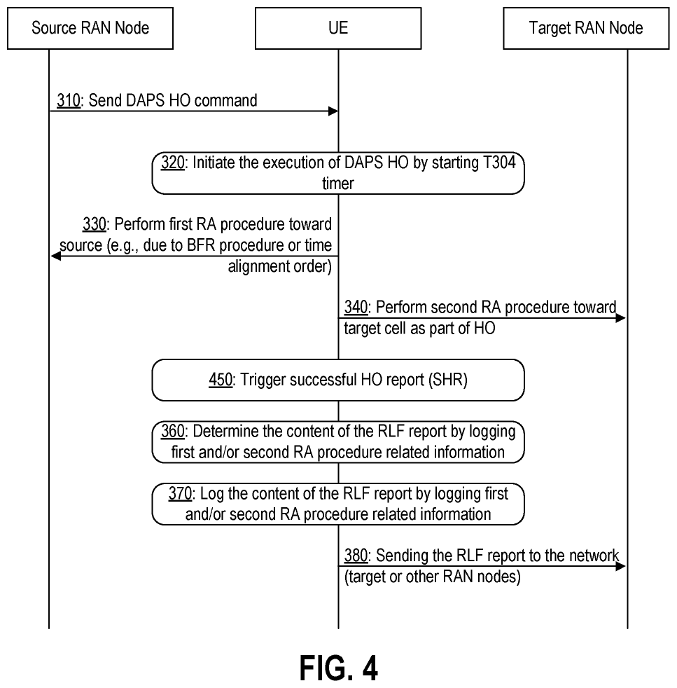

FIG. 4 illustrates an example of a dual RA related information logging as part of a SHR. Blocks 310, 320, 330, 340, 360, 370, and 380 are similar to those in FIG. 3. However, rather than declaring a HO failure (block 350 of FIG. 3), at block 405, the UE triggers a successful HO report.

In some embodiments, the communication device determines (e.g., logs/compiles) a SHR upon successful execution of a DAPS HO or a reconfiguration with sync including a DAPS bearer configuration.

In some embodiments, the communication device performs a DAPS HO toward a target cell after receiving a reconfiguration with sync command from the network node, and performs a first RA procedure toward a source cell while performing DAPS HO, and while performing a second RA procedure toward the target as part of the DAPS HO that led to a SHR (e.g., some of the SHR triggering conditions configured as port of SHR configuration were fulfilled during the DAPS HO).

In additional or alternative embodiments, the communication device further determines content of the SHR (logged after successful execution of the DAPS HO) to be sent to the network after successful execution of the DAPS HO. For example, the communication device determines whether to include the information of the first RA procedure and/or the information of the second RA procedure. In some examples, the UE logs the information pertaining to the first RA procedure performed toward the source cell (e.g., RA-InformationCommon pertaining to the first RA procedure). In additional or alternative examples, the UE logs the information pertaining to the RA procedure performed toward the target cell (e.g., RA-InformationCommon pertaining to the second RA procedure). In additional or alternative examples, the UE logs the information pertaining to both RA procedures performed toward the source and the target RAN nodes (e.g., two RA-InformationCommon one pertaining to the first RA procedure and one pertaining to the second RA procedure).

In some examples, the communication device determines the content of the RLF report based on the procedural text in RRC TS 38.331 explicitly indicating to collect which RA information.

In additional or alternative examples, the communication device determines the RA report information as part of the SHR based on the configuration received from the network node (e.g., a gNB or OAM or SMO). For example, the network node instructs the UE to log the RA information pertaining to the source cell, the RA information pertaining to the target cell, or the information pertained to both of RA procedure.

In additional or alternative embodiments, the communication device logs the content of the report. In some examples, if the frequency resources used for the first random access procedure and the second random access procedure is the same, then the UE includes one set of information associated to the frequency resources that is common to the first random access procedure and the second random access procedure and the UE also includes another set of information associated to each random access attempts in the first random access procedure and the second random access procedure. By doing so, the UE reduces the size of the report.

In additional or alternative embodiments, the communication device transmits the SHR to the network node (e.g., via a UE Information request Response procedure).

A non-limiting example of the operations illustrated in FIG. 4 are in the modified portion of the 3GPP technical specification 38.331 below:
1>if the ratio between the value of the elapsed time of the timer T304 and the configured value of the timer T304, included in the last applied RRCReconfiguration message including the reconfigurationWithSync, is greater than thresholdPercentage T304 included in the successHO-Config received before executing the last reconfiguration with sync; or
1>if the ratio between the value of the elapsed time of the timer T310 and the configured value of the timer T310, configured while the UE was connected to the source PCell before executing the last reconfiguration with sync, is greater than thresholdPercentage T310 included in the successHO-Config configured by the source PCell before executing the last reconfiguration with sync; or
1>if the ratio between the value of the elapsed time of the timer T312 and the configured value of the timer T312, configured while the UE was connected to the source PCell before executing the last reconfiguration with sync, is greater than thresholdPercentage T312 included in the successHO-Config configured by the source PCell before executing the last reconfiguration with sync; or
1>if the last executed handover was a DAPS handover and if an RLF occurred at the source PCell during the DAPS handover while T304 was running:
   2>store the successful handover information in VarSuccessHO-Report and determine the content in VarSuccessHO-Report as follows:
   2>store the successful handover information in VarSuccessHO-Report and determine the content in VarSuccessHO-Report as follows:
      3>clear the information included in VarSuccessHO-Report, if any;
      3>for the source PCell in which the last RRCReconfiguration message including reconfigurationWithSync was applied:
         4>if the last executed handover was a DAPS handover and if an RLF occurred at the source PCell during the DAPS handover while T304 was running:
         5>set the rlfInSource-DAPS in sourceCellInfo to true;
         5>set the ra-InformationCommonSource to include the random-access related information executed as part of handover (or reconfiguration with sync) toward source cell, if the UE performed random access procedure toward source cell while T304 timer was running;
         [some unaffected text omitted]
      3>if the ratio between the value of the elapsed time of the timer T304 and the configured value of the T304 timer, included in the last applied RRCReconfiguration message including the reconfigurationWithSync, is greater than thresholdPercentage T304 included in the successHO-Config received before executing the last reconfiguration with sync:
         4>set t304-cause in shr-Cause to true;
         4>set the ra-InformationCommon of the random access procedure performed toward target PCell.

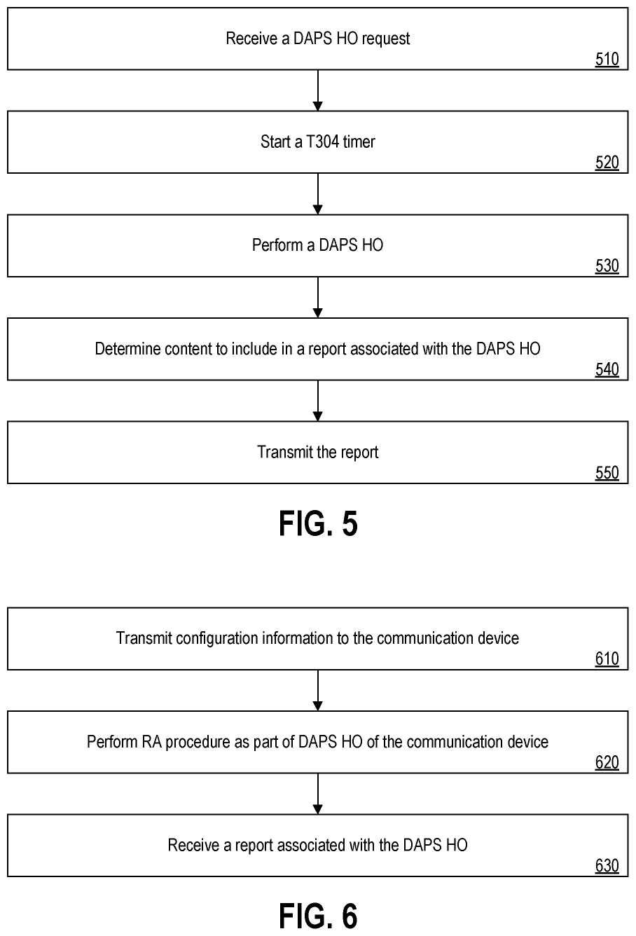

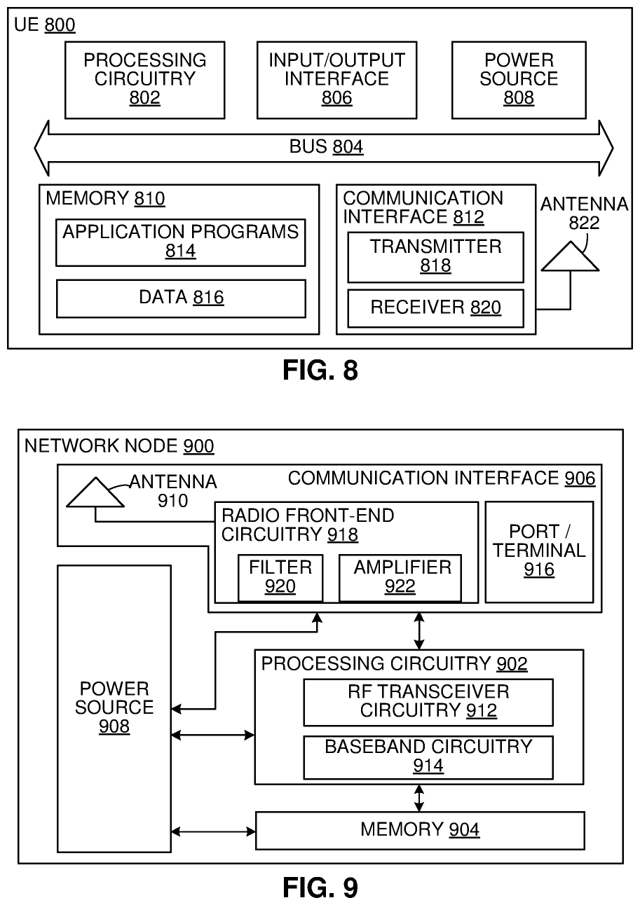

In the description that follows, while the communication device may be any of UE 712A-D, 800, hardware 1104, or virtual machine 1108A, 1108B, the communication device 800 shall be used to describe the functionality of the operations of the communication device. Operations of the communication device 800 (implemented using the structure of FIG. 8) will now be discussed with reference to the flow chart of FIG. 5 according to some embodiments of inventive concepts. For example, modules may be stored in memory 810 of FIG. 8, and these modules may provide instructions so that when the instructions of a module are executed by respective communication device processing circuitry 802, processing circuitry 802 performs respective operations of the flow chart.

FIG. 5 illustrates an example of operations performed by a communication device of a communications network.

At block 510, processing circuitry 802 receives, via communication interface 812, a DAPS HO request.

At block 520, processing circuitry 802 starts a T304 timer.

At block 530, processing circuitry 802 performs a DAPS HO. In some embodiments, the DAPS HO is from a source cell associated with a first network node of the communications network to a target cell of a second network node (e.g., a different network node than the first network node or the same network node as the first network node).

At block 540, processing circuitry 802 determines content to include in a report associated with the DAPS HO. In some embodiments, performing the DAPS HO includes: performing a first RA procedure with the source cell and performing a second RA procedure with the target cell. Determining the content to include in the report comprises determining to include at least one of: information associated with the first RA procedure; and information associated with the second RA procedure. In some examples, the information associated with the first RA procedure includes RA-InformationCommon pertaining to the first RA procedure, and the information associated with the second RA procedure includes RA-InformationCommon pertaining to the second RA procedure.

In some embodiments, first frequency resources are used for the first RA procedure, second frequency resources are used for the second RA procedure, and third frequency resources are used for both the first RA procedure and the second RA procedure. Determining the content can include determining to include a first set of information associated with the first frequency resources, a second set of information associated with the second set of frequency resources, and a third set of information associated with the third set of frequency resources. In some examples, grouping the information related to common frequency resources can reduce the size of the report.

In additional or alternative embodiments, determining the content to include in the report includes determining the content based on predetermined configuration information (e.g., standardized by the 3GPP).

In additional or alternative embodiments, determining the content to include in the report includes determining the content based on configuration information received from a network node.

In additional or alternative embodiments, determining the content to include in the report includes logging and/or compiling the content.

At block 550, processing circuitry 802 transmits, via communication interface 812, the report. In some embodiments, the report is transmit to the second network node (network node associated with the target cell). In additional or alternative embodiments, the report is transmit to the first network node (network node associated with the source cell) or to another network node of the communications network.

In some embodiments, the DAPS HO is unsuccessful and the report is a RLF report. In additional or alternative embodiments, the DAPS HO is successful and the report is a SHR. In additional or alternative embodiments, transmitting the report includes transmitting the report via an Information Request Response Procedure.

Various operations of FIG. 5 may be optional with respect to some embodiments. For example, in regards to Embodiment 1 (described below), blocks 510 and 520 may be optional.

In the description that follows, while the network node may be any of the network node 710A, 710B, 900, 1206, hardware 1104, or virtual machine 1108A, 1108B, the network node 900 shall be used to describe the functionality of the operations of the network node. Operations of the network node 900 (implemented using the structure of FIG. 9) will now be discussed with reference to the flow charts of FIG. 6 according to some embodiments of inventive concepts. For example, modules may be stored in memory 904 of FIG. 9, and these modules may provide instructions so that when the instructions of a module are executed by respective network node processing circuitry 902, processing circuitry 902 performs respective operations of the flow chart.

FIG. 6 illustrates an example of operations performed by a network node of a communications network.

At block 610, processing circuitry 902 transmits, via communication interface 906, configuration information. In some embodiments, the configuration information instructs the communication device on what information to include in the content.

At block 620, processing circuitry 902 performs a RA procedure as part of a DAPS HO of a communication device from a source cell to a target cell. In some embodiments, the network node is a source network node associated with the source cell. In additional or alternative embodiments, the network node is a target network node associated with the target cell.

At block 630, processing circuitry 902 receives, via communication interface 906, a report associated with the DAPS HO. In some embodiments, the DAPS HO is unsuccessful and the report is a RLF report. In additional or alternative embodiments, the DAPS HO is successful and the report is a SHR. In additional or alternative embodiments, receiving the report includes receiving the report via an Information Request Response Procedure. In additional or alternative embodiments, receiving the report includes receiving the report from at least one of: the communication device; and another network node in the communications network.

In some embodiments, the DAPS HO includes the communication device performing a first RA procedure with the source cell and performing a second RA procedure with the target cell. Content of the report includes at least one of: information associated with the first RA procedure; and information associated with the second RA procedure. In some examples, the information associated with the first RA procedure includes RA-InformationCommon pertaining to the first RA procedure, and the information associated with the second RA procedure includes RA-InformationCommon pertaining to the second RA procedure.

In some embodiments, first frequency resources are used for the first RA procedure, second frequency resources are used for the second RA procedure, and third frequency resources are used for both the first RA procedure and the second RA procedure. The content of the report can include a first set of information associated with the first frequency resources, a second set of information associated with the second set of frequency resources, and a third set of information associated with the third set of frequency resources. In some examples, grouping the information related to common frequency resources can reduce the size of the report.

Various operations of FIG. 30 may be optional with respect to some embodiments. For example, in regards to Embodiment 14 (described below), block 610 may be optional.

Example Embodiments are described below.

Embodiment 1. A method of operating a communication device of a communications network, the method comprising:
performing (530) a dual active protocol stack, DAPS, handover, HO, from a source cell associated with a first network node of the communications network to a target cell associated with a second network node of the communications network;
determining (540) content to include in a report associated with the DAPS HO; and
transmitting (550) the report to a third network node of the communications network. toward a target cell

Embodiment 2. The method of Embodiment 1, wherein performing the DAPS HO comprises:
performing a first random access, RA, procedure with the source cell; and
performing a second RA procedure with the target cell.

Embodiment 3. The method of Embodiment 2, wherein determining the content to include in the report comprises determining to include at least one of: information associated with the first RA procedure; and information associated with the second RA procedure.

Embodiment 4. The method of Embodiment 3, wherein the information associated with the first RA procedure comprises RA-InformationCommon pertaining to the first RA procedure, and
wherein the information associated with the second RA procedure comprises RA-InformationCommon pertaining to the second RA procedure.

Embodiment 5. The method of any of Embodiments 3-4, wherein first frequency resources are used for the first RA procedure,
wherein second frequency resources are used for the second RA procedure,
wherein third frequency resources are used for both the first RA procedure and the second RA procedure, and
wherein determining the content to include in the report comprises determining to include a first set of information associated with the first frequency resources, a second set of information associated with the second set of frequency resources, and a third set of information associated with the third set of frequency resources.

Embodiment 6. The method of any of Embodiments 1-5, wherein determining the content to include in the report comprises determining the content based on predetermined configuration information.

Embodiment 7. The method of any of Embodiments 1-5, wherein determining the content to include in the report comprises determining the content based on configuration information received from a network node.

Embodiment 8. The method of any of Embodiments 1-7, wherein determining the content to include in the report comprises logging and/or compiling the content.

Embodiment 9. The method of any of Embodiments 1-8, further comprising:
receiving (510) a DAPS HO request from the first network node; and
responsive to receiving the DAPS HO request, starting (520) a T304 timer.

Embodiment 10. The method of any of Embodiments 1-9, wherein the DAPS HO is unsuccessful, and
wherein the report is a radio link failure, RLF, report.

Embodiment 11. The method of any of Embodiments 1-10, wherein the DAPS HO is successful, and
wherein the report is a successful handover report, SHR.

Embodiment 12. The method of any of Embodiments 1-11, wherein transmitting the report comprises transmitting the report via an Information Request Response Procedure.

Embodiment 13. The method of any of Embodiments 1-12, wherein the third network node is at least one of: the first network node; and the second network node.

Embodiment 14. A method of operating a network node of a communications network, the method comprising:
performing (620) a random access, RA, procedure with a communication device as part of a dual active protocol stack, DAPS, handover, HO, of the communication device from a source cell to a target cell;
receiving (630) a report including content associated with the DAPS HO.

Embodiment 15. The method of Embodiment 14, wherein the network node is a source network node associated with the source cell.

Embodiment 16. The method of any of Embodiments 14-15, wherein the network node is a target network node associated with the target cell.

Embodiment 17. The method of any of Embodiments 14-16, wherein the DAPS HO comprises:
a first random access, RA, procedure between the communication device and the source cell; and
a second RA procedure between the communication device and the target cell.

Embodiment 18. The method of Embodiment 17, wherein the content includes at least one of: information associated with the first RA procedure; and information associated with the second RA procedure.

Embodiment 19. The method of Embodiment 18, wherein the information associated with the first RA procedure comprises RA-InformationCommon pertaining to the first RA procedure, and
wherein the information associated with the second RA procedure comprises RA-InformationCommon pertaining to the second RA procedure.

Embodiment 20. The method of any of Embodiments 18-19, wherein first frequency resources are used for the first RA procedure,
wherein second frequency resources are used for the second RA procedure,
wherein third frequency resources are used for both the first RA procedure and the second RA procedure, and
wherein the content includes a first set of information associated with the first frequency resources, a second set of information associated with the second set of frequency resources, and a third set of information associated with the third set of frequency resources.

Embodiment 21. The method of any of Embodiments 14-20, further comprising:
transmitting (610) configuration information to the communication device instructing the communication device on what information to include in the content.

Embodiment 22. The method of any of Embodiments 14-21, wherein the DAPS HO is unsuccessful, and
wherein the report is a radio link failure, RLF, report.

Embodiment 23. The method of any of Embodiments 14-21, wherein the DAPS HO is successful, and
wherein the report is a successful handover report, SHR.

Embodiment 24. The method of any of Embodiments 14-23, wherein receiving the report comprises receiving the report via an Information Request Response Procedure.

Embodiment 25. The method of any of Embodiments 14-14, wherein receiving the report comprises receiving the report from at least one of: the communication device; and another network node in the communications network.

Embodiment 26. A communication device (712A-D, 800, 1104) operating in a communications network, the communication device comprising:
processing circuitry (802); and
memory (810) coupled to the processing circuitry and having instructions stored therein that are executable by the processing circuitry to cause the communication device to perform operations comprising any of the operations of Embodiments 1-13.

Embodiment 27. A computer program comprising program code to be executed by processing circuitry (802) of a communication device (712A-D, 800, 1104) operating in a communications network, whereby execution of the program code causes the communication device to perform operations comprising any operations of Embodiments 1-13.

Embodiment 28. A computer program product comprising a non-transitory storage medium (810) including program code to be executed by processing circuitry (802) of a communication device (712A-D, 800, 1104) operating in a communications network, whereby execution of the program code causes the communication device to perform operations comprising any operations of Embodiments 1-13.

Embodiment 29. A non-transitory computer-readable medium having instructions stored therein that are executable by processing circuitry (802) of a communication device (712A-D, 800, 1104) operating in a communications network to cause the communication device to perform operations comprising any of the operations of Embodiments 1-13.

Embodiment 30. A network node (708, 710A, 710B, 900, 1206, 1104, 1108A, 1108B) operating in a communications network, the network node comprising:
processing circuitry (902); and
memory (904) coupled to the processing circuitry and having instructions stored therein that are executable by the processing circuitry to cause the network node to perform operations comprising any of the operations of Embodiments 14-25.

Embodiment 31. A computer program comprising program code to be executed by processing circuitry (902) of a network node (708, 710A, 710B, 900, 1206, 1104, 1108A, 1108B) operating in a communications network, whereby execution of the program code causes the network node to perform operations comprising any operations of Embodiments 14-25.

Embodiment 32. A computer program product comprising a non-transitory storage medium (904) including program code to be executed by processing circuitry (902) of a network node (708, 710A, 710B, 900, 1206, 1104, 1108A, 1108B) operating in a communications network, whereby execution of the program code causes the network node to perform operations comprising any operations of Embodiments 14-25.

Embodiment 33. A non-transitory computer-readable medium having instructions stored therein that are executable by processing circuitry (902) of a network node (708, 710A, 710B, 900, 1206, 1104, 1108A, 1108B) operating in a communications network to cause the network node to perform operations comprising any of the operations of Embodiments 14-25.

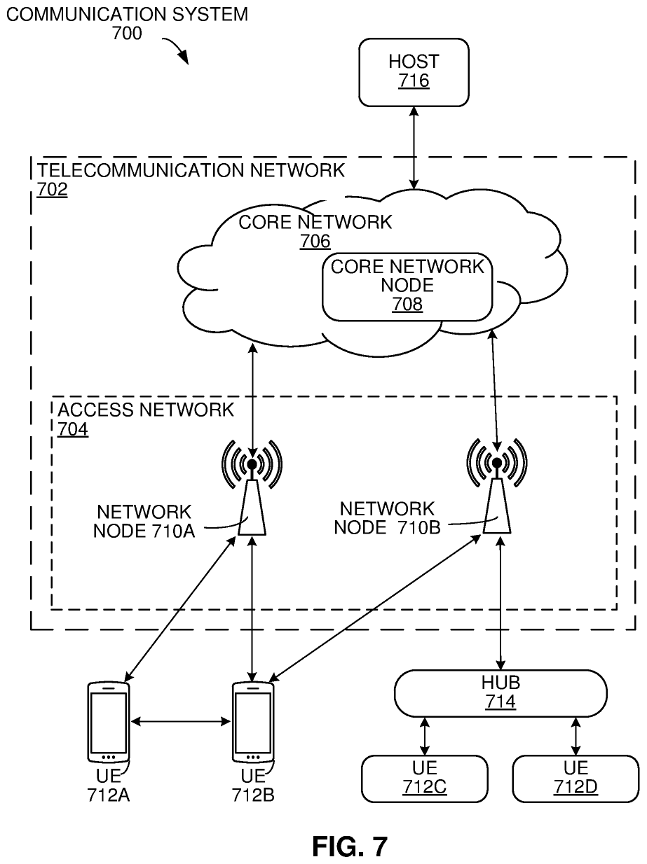

FIG. 7 shows an example of a communication system 700 in accordance with some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3rd Generation Partnership Project (3GPP) access node or non-3GPP access point. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

FIG. 8 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

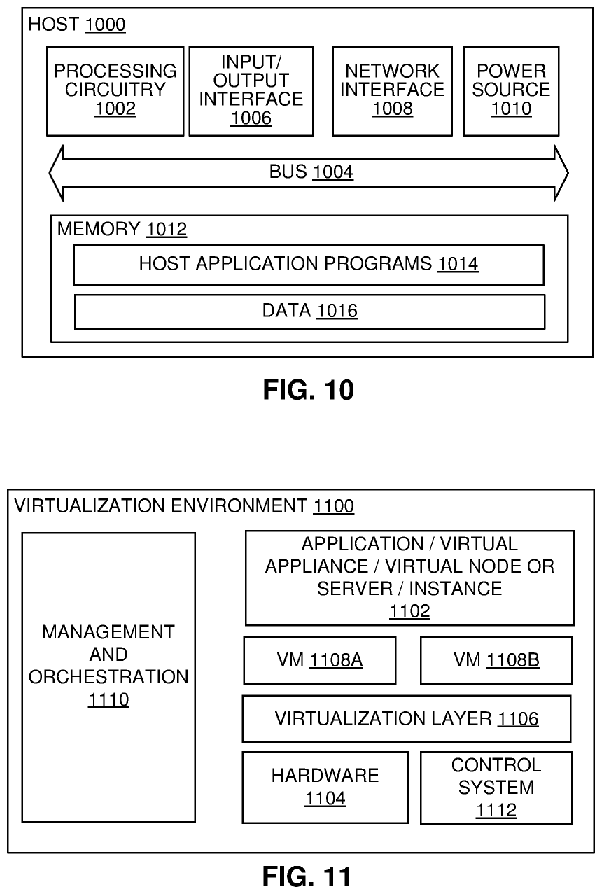

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g. such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

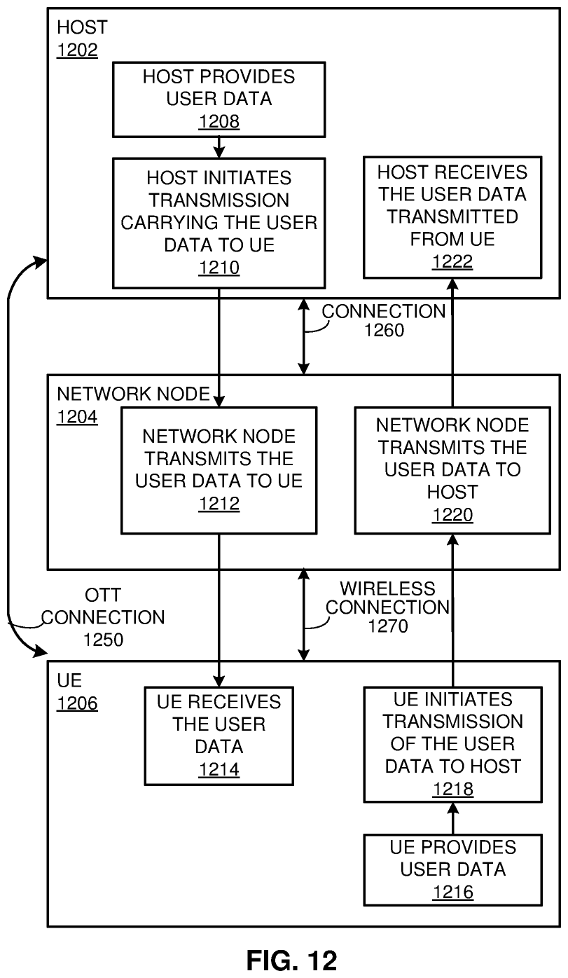

FIG. 12 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. More precisely, the teachings of these embodiments may enable the UE to log the random-access information in a predetermined way according to the procedure specified in 3GPP specifications (e.g., TS 38.331) or according to a configuration received from the network. As a result, the network node receiving the report (RLF or SHR) after execution of the HO, will recognize if the random-access related information belongs to the source cell or to the target cell of the handover. Therefore, further optimization concerning the RA procedure would not be misled.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method of operating a communication device of a communications network, the method comprising:
performing a dual active protocol stack, DAPS, handover, HO, from a source cell associated with a first network node of the communications network to a target cell associated with a second network node of the communications network, which includes performing a first random access, RA, procedure with the source cell and performing a second RA procedure with the target cell;
determining RA content to include in a report associated with the DAPS HO; and
transmitting the report to a third network node of the communications network toward a target cell.

2. The method of claim 1, wherein determining the RA content to include in the report comprises determining to include at least one of: information associated with the first RA procedure; and information associated with the second RA procedure.

3. The method of claim 2, wherein the information associated with the first RA procedure comprises RA-InformationCommon pertaining to the first RA procedure, and
wherein the information associated with the second RA procedure comprises RA-InformationCommon pertaining to the second RA procedure.

4. The method of claim 2, wherein first frequency resources are used for the first RA procedure,
wherein second frequency resources are used for the second RA procedure,
wherein third frequency resources are used for both the first RA procedure and the second RA procedure, and
wherein determining the RA content to include in the report comprises determining to include a first set of information associated with the first frequency resources, a second set of information associated with the second set of frequency resources, and a third set of information associated with the third set of frequency resources.

5. The method of claim 1, wherein determining the RA content to include in the report comprises determining the RA content based on predetermined configuration information.

6. The method of claim 1, wherein determining the RA content to include in the report comprises determining the RA content based on configuration information received from a network node.

7. The method of claim 1, further comprising:
receiving a DAPS HO request from the first network node; and
responsive to receiving the DAPS HO request, starting a T304 timer.

8. The method of claim 7, wherein determining the RA content comprises:
responsive to determining a ratio between an amount of time since starting the T304 and a preconfigured value associated with the T304 timer exceeds a threshold value, determining the RA content based on the ratio exceeds the threshold value.

9. The method of claim 1, wherein the DAPS HO is unsuccessful, and
wherein the report is a radio link failure, RLF, report.

10. The method of claim 1, wherein the DAPS HO is successful, and
wherein the report is a successful handover report, SHR.

11. The method of claim 1, wherein transmitting the report comprises transmitting the report via an Information Request Response Procedure.

12. The method of claim 1, wherein the third network node is at least one of: the first network node; and the second network node.

13. A method of operating a network node of a communications network, the method comprising:
performing a random access, RA, procedure with a communication device as part of a dual active protocol stack, DAPS, handover, HO, of the communication device from a source cell to a target cell; and
receiving a report including RA content associated with the DAPS HO.

14. The method of claim 13, wherein the network node is a source network node associated with the source cell.

15. The method of claim 13, wherein the network node is a target network node associated with the target cell.

16. The method of claim 13, wherein the DAPS HO comprises:
a first random access, RA, procedure between the communication device and the source cell; and
a second RA procedure between the communication device and the target cell.

17. The method of claim 16, wherein the RA content includes at least one of: information associated with the first RA procedure; and information associated with the second RA procedure.

18. The method of claim 17, wherein the information associated with the first RA procedure comprises RA-InformationCommon pertaining to the first RA procedure, and
wherein the information associated with the second RA procedure comprises RA-InformationCommon pertaining to the second RA procedure.

19. The method of claim 17, wherein first frequency resources are used for the first RA procedure,
wherein second frequency resources are used for the second RA procedure,
wherein third frequency resources are used for both the first RA procedure and the second RA procedure, and
wherein the RA content includes a first set of information associated with the first frequency resources, a second set of information associated with the second set of frequency resources, and a third set of information associated with the third set of frequency resources.

20. The method of claim 13, further comprising:
transmitting configuration information to the communication device instructing the communication device on what information to include in the RA content.

21. The method of claim 13, wherein the DAPS HO is unsuccessful, and
wherein the report is a radio link failure, RLF, report.

22. The method of claim 13, wherein the DAPS HO is successful, and
wherein the report is a successful handover report, SHR.

23. The method of claim 13, wherein receiving the report comprises receiving the report via an Information Request Response Procedure.

24. The method of claim 13, wherein receiving the report comprises receiving the report from at least one of: the communication device; and another network node in the communications network.

25. A communication device operating in a communications network, the communication device comprising:
processing circuitry; and
memory coupled to the processing circuitry and having instructions stored therein that are executable by the processing circuitry to cause the communication device to perform operations comprising any of the operations of claim 1.

26.-27. (canceled)

28. A network node operating in a communications network, the network node comprising:
processing circuitry; and
memory coupled to the processing circuitry and having instructions stored therein that are executable by the processing circuitry to cause the network node to perform operations comprising any of the operations of claim 13.

29.-30. (canceled)
